(19) United States
(12) Patent Application Publication
(10) Pub. No.: US 2014/0362399 A1
(43) Pub. Date: Dec. 11, 2014

(54) IMAGE FORMING APPARATUS AND NON-TRANSITORY COMPUTER READABLE MEDIUM

(71) Applicant: FUJI XEROX CO., LTD., Tokyo (JP)

(72) Inventors: Hideaki SUGIMOTO, Kanagawa (JP); Nozomi NOGUCHI, Kanagawa (JP); Shinichi NAKAMURA, Kanagawa (JP)

(73) Assignee: FUJI XEROX CO., LTD., Tokyo (JP)

(21) Appl. No.: 14/086,590

(22) Filed: Nov. 21, 2013

(30) Foreign Application Priority Data
Jun. 7, 2013 (JP) 2013-121324

(51) Int. Cl. H04N 1/00; G06F 3/12

(52) U.S. Cl. CPC H04N 1/00381; G06F 3/12
USPC 358/1.15

(57) ABSTRACT

An image forming apparatus includes a registration unit and a display. The registration unit registers an address that has been inputted. The display displays, in the case where the number of addresses that have been registered is less than a threshold, a first operation image, the first operation image including a first image for operating the image forming apparatus. The display displays, in the case where the number of addresses that have been registered is not less than the threshold, a second operation image, the second operation image including the address that has been registered and a second image for operating the image forming apparatus, the second image being smaller in display size than the first image.

### CROSS-REFERENCE TO RELATED APPLICATIONS

This application is based on and claims priority under 35 USC 119 from Japanese Patent Application No. 2013-121324 filed Jun. 7, 2013.

### BACKGROUND

(i) Technical Field

The present invention relates to an image forming apparatus and a non-transitory computer readable medium.

(ii) Related Art

On a display such as a touch panel provided in an image forming apparatus according to the related art, such as a facsimile machine or a multifunction machine, an input item such as an inputted address for facsimile transmission and a function icon such as a phonebook opening icon are displayed, for example. In this case, plural input items may be displayed.

### SUMMARY

According to an aspect of the present invention, there is provided an image forming apparatus including a registration unit and a display. The registration unit registers an address that has been inputted. The display displays, in the case where the number of addresses that have been registered is less than a threshold, a first operation image, the first operation image including a first image for operating the image forming apparatus. The display displays, in the case where the number of addresses that have been registered is not less than the threshold, a second operation image, the second operation image including the address that has been registered and a second image for operating the image forming apparatus, the second image being smaller in display size than the first image.

### BRIEF DESCRIPTION OF THE DRAWINGS

An exemplary embodiment of the present invention will be described in detail based on the following figures, wherein:

FIG. 1 is a block diagram illustrating an image forming apparatus according to the exemplary embodiment of the present invention;

FIGS. 2A and 2B are diagrams each illustrating an example of an operation image displayed in the image forming apparatus according to the exemplary embodiment of the present invention;

FIG. 3 is a diagram illustrating an example of the content of a memory in the image forming apparatus according to the exemplary embodiment of the present invention;

FIGS. 4A and 4B are diagrams each illustrating an example of an image layout in the image forming apparatus according to the exemplary embodiment of the present invention;

FIG. 5 is a diagram illustrating examples of icon images in the image forming apparatus according to the exemplary embodiment of the present invention;

FIG. 6 is a flowchart illustrating an example of processing of a display program in the image forming apparatus according to the exemplary embodiment of the present invention;

FIG. 7 is a diagram illustrating examples of changes in the icon images over time in the image forming apparatus according to the exemplary embodiment of the present invention; and

FIGS. 8A to 8G are diagrams illustrating examples of images that complement the two operation images in the image forming apparatus according to the exemplary embodiment of the present invention.

### DETAILED DESCRIPTION

An exemplary embodiment of the present invention is described below with reference to the accompanying drawings.

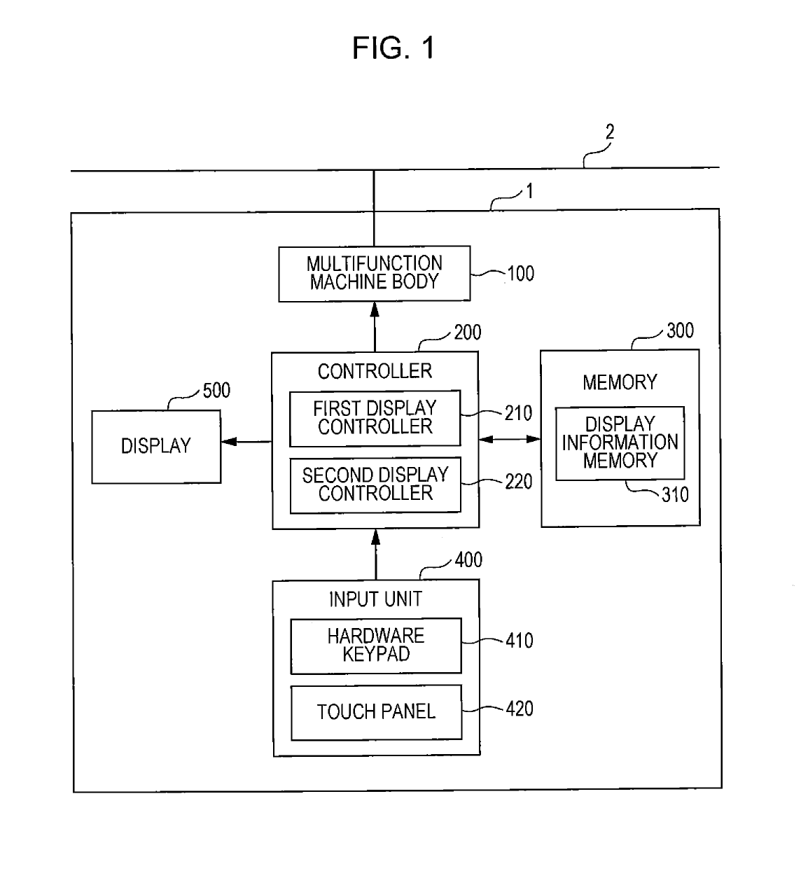

FIG. 1 is a diagram illustrating an example of a configuration of a multifunction machine 1 according to the exemplary embodiment of the present invention. As illustrated in FIG. 1, the multifunction machine 1 includes a multifunction machine body 100, a controller 200, a memory 300, an input unit 400, and a display 500. The controller 200, the memory 300, the input unit 400, and the display 500 integrally function as a computer.

The multifunction machine body 100 includes a portion having functions of a copier, a printer, a scanner, a facsimile machine, and so forth. The multifunction machine body 100 is connected to a communication line 2 to allow transmission and reception of a print job or facsimile transmission and reception.

The controller 200 includes a central processing unit (CPU), for example, and executes a program stored in the memory 300 to thereby control the multifunction machine 1. The controller 200 also executes a display program on the basis of display information stored in the memory 300 to thereby control generation of operation images and display of the operation images on the display 500, the generation and display being functions of a first display controller 210 and a second display controller 220. The processing of the display program is specifically described below in detail.

The memory 300 includes a random access memory (RAM) and a read only memory (ROM), for example. In the memory 300, the program executed by the controller 200 is stored. The memory 300 also functions as a work memory of the controller 200. In this exemplary embodiment, the memory 300 includes a display information memory 310, in which the display information described above is stored. Note that the program stored in the memory 300 and executed by the controller 200 may be provided via a telecommunication line or may be stored in a computer readable information storage medium such as a semiconductor memory element and provided therefrom.

The input unit 400 outputs an instruction inputted by a user to the controller 200. In this exemplary embodiment, the input unit 400 includes a hardware keypad 410 and a touch panel 420.

The display 500 is a liquid crystal display, for example, on which information and the like necessary for a user to operate the multifunction machine 1 is displayed. In this exemplary embodiment, the display 500 and the touch panel 420 included in the input unit 400 integrally form a user interface and the multifunction machine 1 is operated by a user tapping on an icon image displayed on the display 500.

Here, “tapping” is an action of lightly striking a touch panel with the tip of a finger. As in this exemplary embodiment, in the case where the display 500 and the touch panel 420 integrally form a user interface, when an icon image displayed at the position touched with the tip of a finger is specified by a tapping action, a function of the multifunction machine 1, which is related to the tapped icon image, is called.

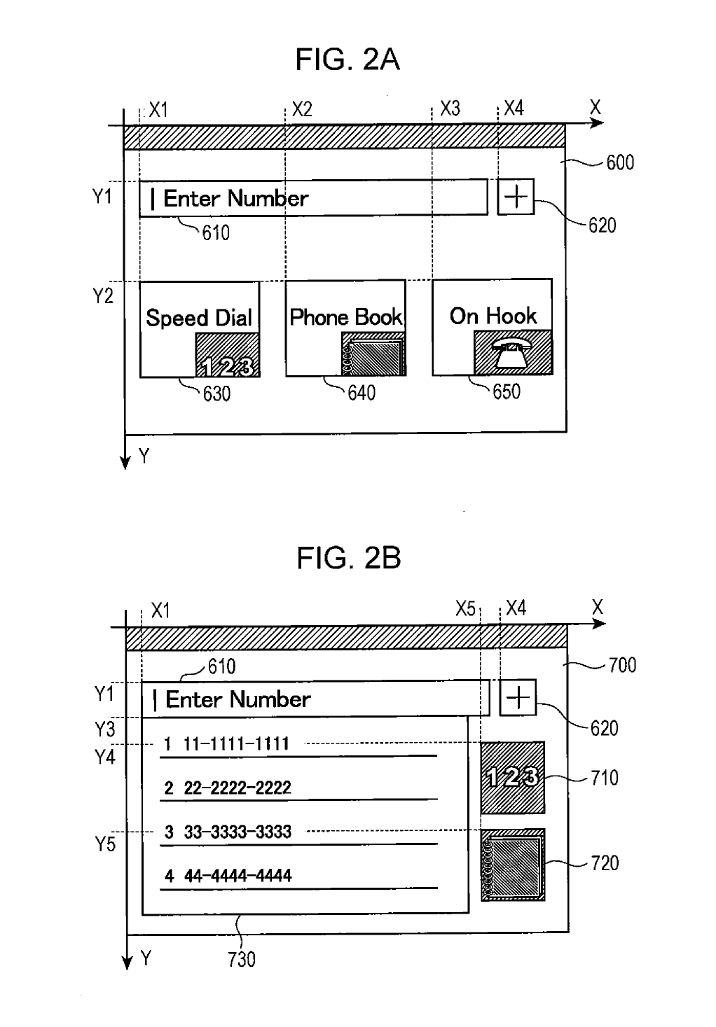

FIG. 2A illustrates a first operation image 600 generated and displayed on the display 500 by the first display controller 210 in this exemplary embodiment. The vertical axis and horizontal axis in FIGS. 2A and 2B represent the reference lines of image display coordinates. Here, suppose that x1 to x5 and y1 to y5, which are symbols used for the display coordinates, each represent a predetermined numerical value.

In this exemplary embodiment, suppose that all the images are images of rectangles and are arranged parallel to the reference lines, and the image display coordinates specify the coordinates of the upper left vertex of each rectangle. In the case where an image of a circle is used, for example, the reference point of the image display coordinates may be the center or the like of the circle.

The first operation image 600 includes an address display field 610, an address registration button 620, a speed dial icon (large size) 630, a phonebook icon (large size) 640, and an on-hook icon 650. As an image displayed in the first operation image 600, an icon or the like related to setting of the multifunction machine 1, for example, may be additionally included.

In the address display field 610, characters such as “Enter Number” are displayed. When a user inputs a number using the hardware keypad 410, the number is displayed in the address display field 610.

In this exemplary embodiment, the speed dial icon (large size) 630 is related to a speed dial function of the facsimile machine, the phonebook icon (large size) 640 is related to a phonebook function thereof, and the on-hook icon 650 is related to an on-hook function thereof. When each of these function icons is tapped by a user, the corresponding facsimile function is executed.

Here, the speed dial function is a function of omitting input of an address that is frequently used, in which an address is replaced by a number of about four digits. The phonebook function is a function in which addresses are stored in the memory 300 together with persons' names, other names, and the like, and indexed in the order of the Japanese syllabary, for example, to thereby make management and retrieval of addresses easier. The on-hook function is a function of making a call while leaving a telephone receiver down (the on-hook state). In the case of a multifunction machine that does not have a receiver, the on-hook function is a function of performing facsimile transmission or the like to an address that is inputted after execution of the on-hook function.

When the address registration button 620 is tapped by a user in the state where an address has been inputted in the address display field 610 and the number of registered addresses becomes one or more, the displayed first operation image 600 is changed to a second operation image 700 described below. In this case, the inputted address is temporarily stored in the memory 300 and retained until facsimile transmission processing is completed.

FIG. 2B illustrates the second operation image 700 in this exemplary embodiment. The second operation image 700 includes the address display field 610, the address registration button 620, a speed dial icon (small size) 710, a phonebook icon (small size) 720, and an address confirmation field 730.

In the second operation image 700, the function icons are smaller in display size than the function icons in the first operation image 600, the on-hook icon 650 is not included, and the number of icons related to facsimile operation is decreased to two from three. The on-hook function is a function of performing facsimile transmission to one address, which is inputted after execution of the on-hook function, as described above and therefore the on-hook function is unable to be executed in the case where two or more addresses for facsimile transmission have been registered. Note that, in this exemplary embodiment, the on-hook icon 650 is not displayed in the second operation image 700; however, a user may set any function icon as an icon that is not displayed.

In the first operation image 600, only an address being inputted is displayed in the address display field 610, while in the second operation image 700, four addresses that have been registered are displayed in the address confirmation field 730. This display state illustrates the case where a user has already registered four addresses. The address confirmation field 730 may be such that, if a user additionally registers an address, a scroll bar will appear in the address confirmation field 730, for example, so that all addresses that have been registered will be browsed by scrolling the address confirmation field 730.

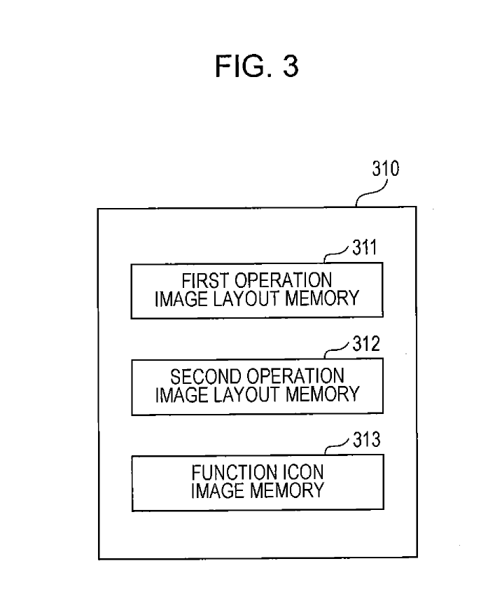

When the first operation image 600 or the second operation image 700 is generated, the controller 200 performs processing on the basis of the display information stored in the display information memory 310 of the memory 300. A specific example of the display information stored in the display information memory 310 in this exemplary embodiment is illustrated in FIG. 3.

In this exemplary embodiment, the display information memory 310 includes a first operation image layout memory 311, a second operation image layout memory 312, and a function icon image memory 313.

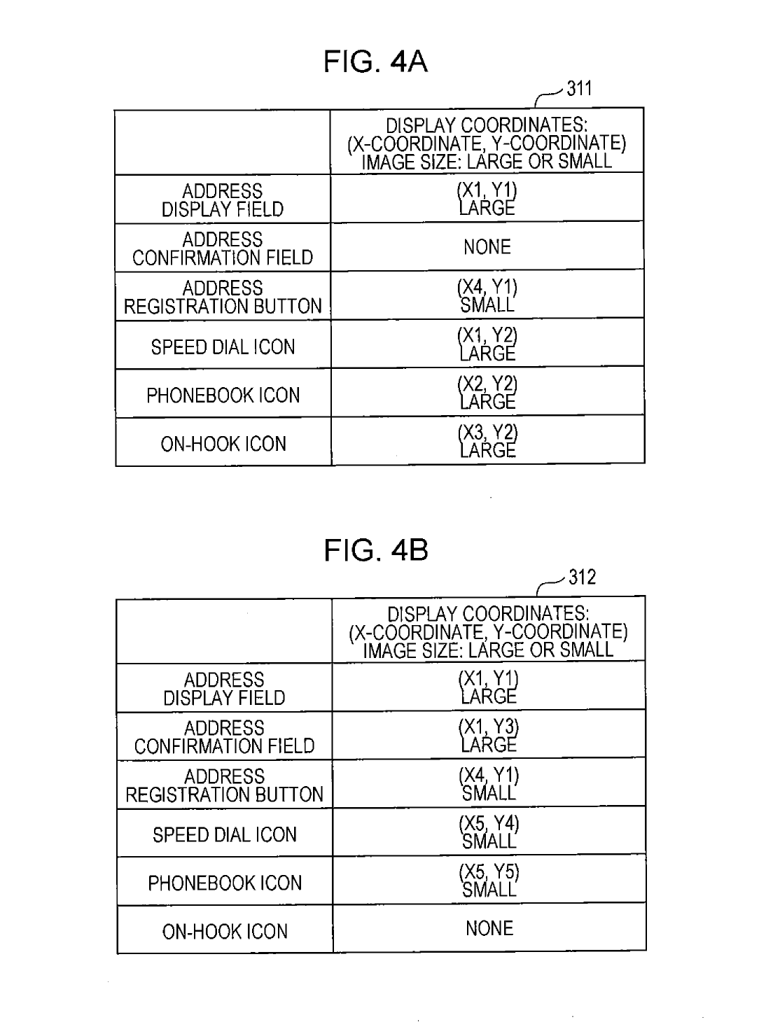

As illustrated in FIG. 4A, first operation image layout information is stored in the first operation image layout memory 311. This information is information on the display coordinates and display size of each of the address display field 610, the address registration button 620, the speed dial icon (large size) 630, the phonebook icon (large size) 640, and the on-hook icon (large size) 650. Second operation image layout information illustrated in FIG. 4B, which is stored in the second operation image layout memory 312, similarly is information on the display coordinates and display size of each of the fields, the button, and the icons.

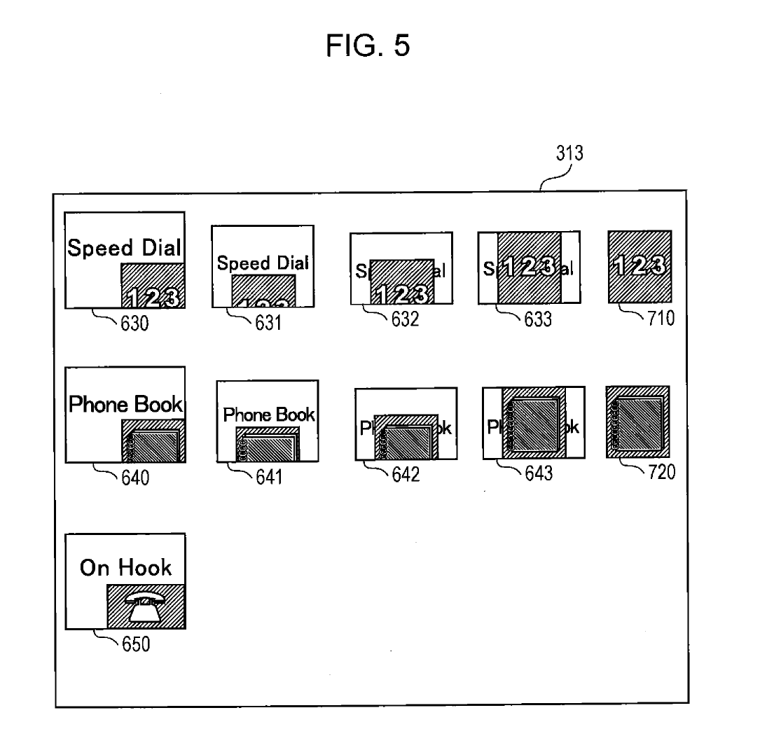

FIG. 5 illustrates an example of the content of the function icon image memory 313. In the function icon image memory 313, image information on the function icons used for generating the first operation image 600 or the second operation image 700 is stored.

In this exemplary embodiment, the images of the speed dial icon (large size) 630, the phonebook icon (large size) 640, and the on-hook icon 650, which are used for generating the first operation image 600, are each constituted by characters and an illustration. The images of the speed dial icon (small size) 710 and the phonebook icon (small size) 720, which are used for generating the second operation image 700, are each constituted by an illustration only.

Here, the speed dial icon (large size) 630 is constituted by the characters “Speed Dial” and an illustration obtained by cutting out part of the speed dial icon (small size) 710, in which the characters describe the speed dial icon (small size) 710. As an illustration included in the speed dial icon (large size) 630, an illustration obtained by performing processing such as enlarging, reducing, rotating, or transparentizing on the speed dial icon (small size) 710, for example, may be used, or an illustration obtained by cutting out part of such a processed icon may be used. The same applies to the phonebook icon (large size) 640.

The facsimile functions may be represented by characters only or abbreviations may be used in a small-sized image, for example.

In the function icon image memory 313, morphing images of the icons are also stored, which are used for generating transition animation. In this exemplary embodiment, for each icon image displayed in the first operation image 600 and a corresponding icon image displayed in the second operation image 700, three images are prepared as images for complementing these icon images; however, any number of images may be prepared as long as at least one image is prepared. When the processing capacity of the controller 200 and the capacity of the memory 300 allow, plural images are desirably prepared for attaining smooth morphing. The morphing in this exemplary embodiment is described below.

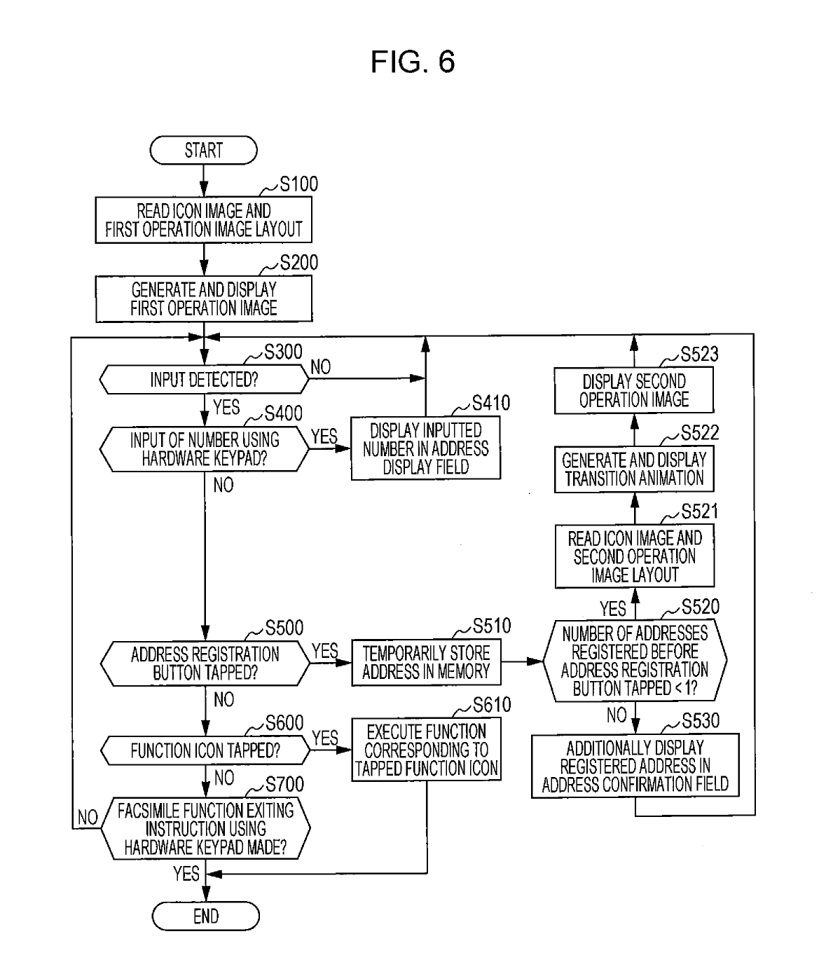

FIG. 6 is a flowchart illustrating the processing of the display program that is executed by the controller 200 when the facsimile functions of the multifunction machine 1 according to this exemplary embodiment are called. The specific flow of this processing is described below with reference to FIG. 6.

First, the first display controller 210 included in the controller 200 reads icon image information and the first operation image layout information stored in the display information memory 310 of the memory 300 (S100), and performs processing of generating the first operation image 600 and displaying the generated first operation image 600 using the display 500 (S200). The controller 200 may first display an image different from the first operation image 600 and, in response to a request from a user, display the first operation image 600.

Next, the controller 200 waits for input of information by a user using the input unit 400 (S300). When there is no input over a certain period of time, the backlight of the display 500 may be turned off, for example.

When input by a user is detected, the controller 200 determines whether the input is input of a number using the hardware keypad 410 (S400). If the input is input of a number using the hardware keypad 410, the controller 200 performs processing of displaying the inputted number in the address display field 610 in the first operation image 600 (S410) and returns to the processing of waiting for input in order to detect another input (S300).

If the input is not input of a number using the hardware keypad 410, the controller 200 determines whether the input is made by a user tapping on the address registration button 620 in the first operation image 600 (S500). If the input is made by a user tapping on the address registration button 620, the controller 200 temporarily stores in the memory 300 an address being displayed in the address display field 610 (S510).

Next, the controller 200 compares the number of addresses, which have been registered before the address registration button 620 is tapped by a user, with 1 (S520). If the number of addresses, which have been registered before the address registration button 620 is tapped by a user, is less than 1, the second display controller 220 included in the controller 200 reads the icon image information and the second operation image layout information stored in the display information memory 310 of the memory 300 (S521), performs processing of generating transition animation and displaying the generated transition animation using the display 500 (S522), and performs processing of displaying the second operation image 700 (S523). Then the controller 200 returns to the processing of waiting for input in order to detect another input (S300).

If the number of addresses, which have been registered before the address registration button 620 is tapped by a user, is not less than 1, the controller 200 performs the processing of generating an image of the second operation image 700, in which the registered address is added to the address confirmation field 730, and displaying the updated second operation image 700 using the display 500 (S530). Then the controller 200 returns to the processing of waiting for input in order to detect another input (S300).

When there is input but the input is not input of a number using the hardware keypad 410 and the input made is not by a user tapping on the address registration button 620, the controller 200 determines whether the input is made by a user tapping on one of the function icons in the first operation image 600 or in the second operation image 700 (S600). If the input is made by a user tapping on one of the function icons, the controller 200 executes a facsimile function corresponding to the tapped function icon (S610).

If the input is made by none of the actions described above, the controller 200 determines whether a facsimile function exiting instruction using the hardware keypad 410 is made (S700). If the facsimile function exiting instruction is made, the controller 200 performs the processing of exiting the facsimile functions and performs the processing of displaying a general menu screen of the multifunction machine 1, for example. If the facsimile function exiting instruction is not made, the controller 200 returns to the processing of waiting for input in order to detect another input (S300).

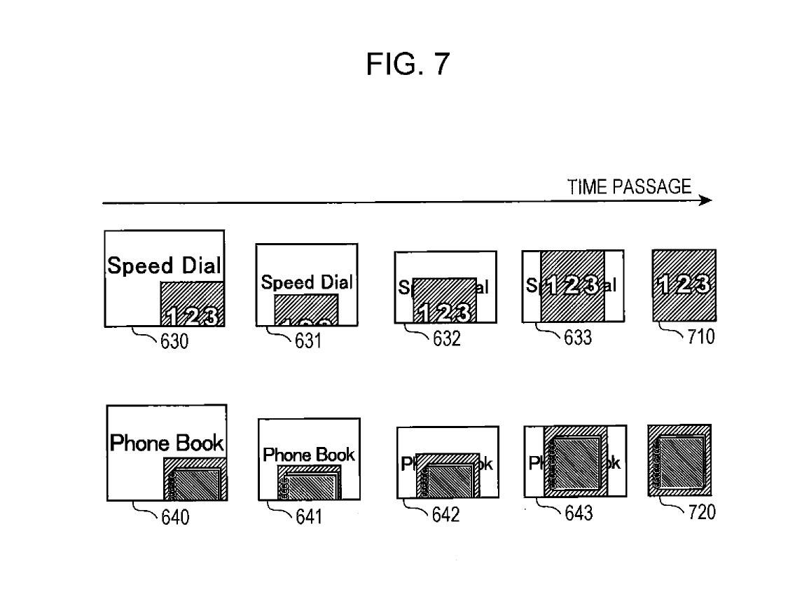

FIG. 7 illustrates morphing using the morphing images of the function icons stored in the function icon image storing unit 313 of the memory 300.

Between the speed dial icon (large size) 630 displayed in the first operation image 600 and the speed dial icon (small size) 710 displayed in the second operation image 700, three images are prepared as the morphing images, which are a speed dial icon (medium size 1) 631 having a slightly smaller image size, a speed dial icon (medium size 2) 632 having a further smaller image size, in which the illustration further emerges, and a speed dial icon (medium size 3) 633, in which the characters are almost hidden behind the illustration. For the phonebook icon (large size) 640, morphing images are similarly prepared.

The second display controller 220 displays such morphing images along the axis of time passage illustrated in FIG. 7 to generate transition animation. When transition animation of any of the function icons is generated, a morphing image may be switched to another morphing image at any time interval; however, the time interval is desirably such that changes by the morphing are visible.

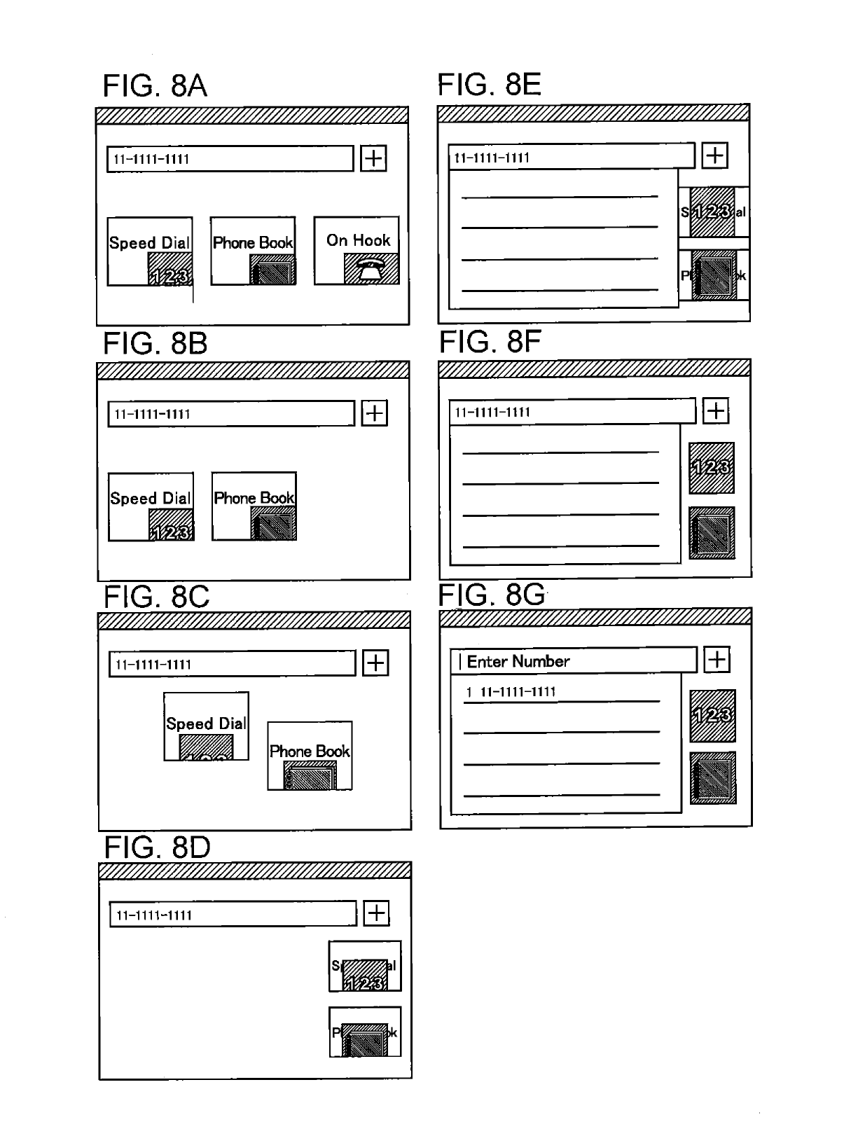

FIGS. 8A to 8G illustrate transition animation generated and displayed on the display 500 by the second display controller 220 in this exemplary embodiment. The flow of the animation is described below.

FIG. 8A illustrates the state where a user inputs one address. When a user taps on the address registration button 620, the second display controller 220 reads the second operation image layout information and the icon image information stored in the display information memory 310 and starts generating transition animation.

FIG. 8B illustrates the first frame of the transition animation. In this frame, the on-hook icon 650 is removed. Note that the function icon may be removed concurrently with other image processing performed in the second or succeeding frames, or may gradually disappear by performing transparentization processing on the icon image, for example.

FIG. 8C illustrates the second frame of the transition animation. In this frame, the speed dial icon (large size) 630 and the phonebook icon (large size) 640 change to the speed dial icon (medium size 1) 631 and a phonebook icon (medium size 1) 641, and the display coordinates thereof change. Note that the changes in the sizes of the function icons do not have to concurrently occur with the changes in the display coordinates, and the changes in the sizes and the changes in the display coordinates may occur in any order.

FIG. 8D illustrates the third frame of the transition animation. In this frame, the speed dial icon (medium size 1) 631 and the phonebook icon (medium size 1) 641 change to the speed dial icon (medium size 2) 632 and a phonebook icon (medium size 2) 642, and the display coordinates thereof change to final display coordinates.

FIG. 8E illustrates the fourth frame of the transition animation. In this frame, the speed dial icon (medium size 2) 632 and the phonebook icon (medium size 2) 642 change to the speed dial icon (medium size 3) 633 and a phonebook icon (medium size 3) 643, and the address confirmation field 730 is concurrently displayed.

FIG. 8F illustrates the fifth frame, which is the last frame of the transition animation. In this frame, the registered address slides toward the address confirmation field 730. The speed dial icon (medium size 3) 633 and the phonebook icon (medium size 3) 643 change to the speed dial icon (small size) 710 and the phonebook icon (small size) 720.

FIG. 8G illustrates the second operation image 700, in which one address has been registered. When a user further inputs an address and taps on the address registration button 620, the registered address is additionally displayed in the address confirmation field 730.

As described above, the operation image is changed in accordance with the state of the facsimile functions in the multifunction machine 1 according to this exemplary embodiment.

It should be noted that the exemplary embodiment of the present invention is not limited to that described above. For example, for functions other than the facsimile functions of the multifunction machine 1 described above, the operation image may be changed in accordance with the states of such functions.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming apparatus comprising:
a registration unit that registers a fax address that has been inputted into an input unit; and
a display
that displays, when the number of fax addresses that have been inputted into the input unit and registered by the registration unit is less than a threshold, a first operation image, the first operation image including a first image for operating the image forming apparatus, and
that displays, when the number of fax addresses that have been inputted into the input unit and registered by the registration unit is not less than the threshold, a second operation image, the second operation image including the fax address that has been registered and a second image for operating the image forming apparatus, the second image being smaller in display size than the first image.

2. The image forming apparatus according to claim 1, wherein
the first image includes part of the second image and a character that describes the second image.

3. The image forming apparatus according to claim 1,
wherein the first operation image includes a first plurality of images for a first plurality of operations of the image forming apparatus,
wherein the second operation image includes a second plurality of images for a second plurality of operations of the image forming apparatus, and
wherein a number of the second plurality of images of the second operation image is smaller than a number of the first plurality of images of the first operation image.

4. The image forming apparatus according to claim 1, wherein,
the display displays at least one image before displaying the second image, the at least one image complementing the first image and the second image.

5. The image forming apparatus according to claim 2, wherein,
the display displays at least one image before displaying the second image, the at least one image complementing the first image and the second image.

6. The image forming apparatus according to claim 3, wherein,
the display displays at least one image before displaying the second image, the at least one image complementing the first image and the second image.

7. A non-transitory computer readable medium storing a program causing a computer included in an image forming apparatus to execute a process for image forming, the process comprising:
registering a fax address that has been inputted into an input unit,
displaying, when the number of fax addresses that have been inputted into the input unit and registered is less than a threshold, a first operation image, the first operation image including a first image for operating the image forming apparatus; and
displaying, when the number of fax addresses that have been inputted into the input unit and registered is not less than the threshold, a second operation image, the second operation image including the fax address that has been registered and a second image for operating the image forming apparatus, the second image being smaller in display size than the first image.
